(19) United States
(12) Patent Application Publication
(10) Pub. No.: US 2024/0246434 A1
(43) Pub. Date: Jul. 25, 2024

(54) PRECAST CHARGING STATION PAD

(71) Applicant: Brice C. Raynor, Harrisville, NH (US)

(72) Inventor: Brice C. Raynor, Harrisville, NH (US)

(21) Appl. No.: 18/518,844

(22) Filed: Nov. 24, 2023

Related U.S. Application Data
(60) Provisional application No. 63/427,801, filed on Nov. 23, 2022.

(51) Int. Cl. B60L 53/30; E02D 27/01

(52) U.S. Cl. CPC B60L 53/30; E02D 27/016

(57) ABSTRACT

Precast charging station pads comprising a base, a first barrier attached to the base, and a conduit chase extending through the base. A method of installing a precast charging station pad having a base, one or more barriers, a conduit chase, and lifting pins, the method comprising digging a hole at least 6 inches wider in each direction as the precast charging station pad, filling the hole with sufficient crushed stone so that the precast charging station pad will be level with a final grade, installing a conduit, placing the precast charging station pad over the conduit using lifting pins, backfilling soil around the precast charging station pad, and compacting the soil.

### CROSS REFERENCE TO RELATED APPLICATIONS/PRIORITY

The present invention claims priority to U.S. Provisional Patent Application No. 63/427,801 filed Nov. 23, 2022, which is incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND

As the negative effects of a carbon economy are being felt worldwide, an increased transition to electric vehicles (EVs) is anticipated. One drawback to purchasing an EV is the lack of charging stations for refueling, but installation of on-site poured concrete charging stations is time consuming and expensive. There is a great need for a charging station that is quicker and less expensive to install, to provide refueling for the wave of new EVs that could be arriving on the roads.

### SUMMARY

Wherefore, it is an object of the present invention to overcome the above-mentioned shortcomings and drawbacks associated with the current technology. The present invention is directed to precast charging station pads and methods of installation of precast charging station pads, preferably allowing for quick installation and reduced clutter and waste associated with pouring concrete onsite.

The presently disclosed invention relates to precast charging station pads comprising a base, a first barrier attached to the base, and a conduit chase extending through the base. According to a further embodiment, the conduit chase is a through hole extending from a top surface of the base, through an interior of the base, to one of a side surface of the base and a bottom surface of the base. According to a further embodiment, the first barrier is a bollard. According to a further embodiment, the first barrier includes rebar. According to a further embodiment, the precast charging station pad comprises a second barrier. According to a further embodiment, the first barrier is spaced from the second barrier in a first direction, and a conduit chase entrance is between the first and second barrier with respect to the first direction. According to a further embodiment, the conduit chase entrance is offset in a second direction orthogonal to the first direction. According to a further embodiment, the first barrier is cast into the base. According to a further embodiment, the first barrier is mechanically attached to the base. According to a further embodiment, the precast charging station pad comprises a charging post attached to the base. According to a further embodiment, a first portion of a surface of the base adjacent to an entrance of the conduit chase has a higher static coefficient of friction than a second portion of the surface of the base. According to a further embodiment, the barrier extends in both a vertical and horizontal direction, with a portion of the barrier extending over the base but spaced from the base in the vertical direction. According to a further embodiment, the barrier has an arch and multiple legs connecting the arch to the base. According to a further embodiment, the precast charging station pad comprises an electrical box precast into the base. According to a further embodiment, the electrical box is adjacent to an entrance of the conduit chase. According to a further embodiment, the precast charging station pad comprises one or more knockouts in the base, with a total number of knockouts being greater than a sum of a number of barriers and a number of conduit chases. According to a further embodiment, the precast charging station pad comprises one or more lifting pins disposed in one or more side surfaces the base. According to a further embodiment, a number of lifting pins is two, three, or four, and each lifting pin is partially embedded in a respective side surface of the base, with an exposed portion of each lifting pin extending from the base into a respective recess in the respective side surface of the base, but the exposed portion of each lifting pin not extending beyond the respective recess.

The presently disclosed invention further relates to precast charging station pads comprising a base formed of concrete, a first barrier and a second barrier attached to the base, a conduit chase extending through the base, the conduit chase being a through hole extending from a top surface of the base, through an interior of the base, to a bottom surface of the base, a charging post positioned vertically over a conduit chase entrance, an electrical box precast into the base at a location adjacent to the entrance of the conduit chase, and between one and four lifting pins disposed in one or more side surfaces the base, where each lifting pin is partially embedded in a respective side surface of the base, with an exposed portion of each pin extending from the base into a respective recess in the respective side surface of the base, but not extending beyond the respective recess, wherein the first and the second barrier are bollards filled with rebar reinforced concrete and covered in a plastic cap, the first barrier is spaced from the second barrier in a first direction, and the conduit chase entrance is between the first and second barrier with regards to the first direction, but is offset in a second direction orthogonal to the first direction, and a first portion of a surface of the base adjacent to an entrance of the conduit chase has a higher static coefficient of friction than a second portion of the surface of the base.

The presently disclosed invention further relates to methods of installing a precast charging station pad having a base, one or more barriers, a conduit chase, and lifting pins, the method comprising digging a hole at least 6 inches wider in each direction as the precast charging station pad, filling the hole with sufficient crushed stone so that the precast charging station pad will be level with a final grade, installing a conduit, placing the precast charging station pad over the conduit using lifting pins, backfilling soil around the precast charging station pad, and compacting the soil.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

The accompanying drawings, which are incorporated in and constitute a part of the specification, illustrate various embodiments of the invention and together with the general description of the invention given above and the detailed description of the drawings given below, serve to explain the principles of the invention. It is to be appreciated that while the accompanying drawings are to scale for one or more embodiments, the emphasis is instead placed on illustrating the principles of the invention. The invention will now be described, by way of example, with reference to the accompanying drawings in which:

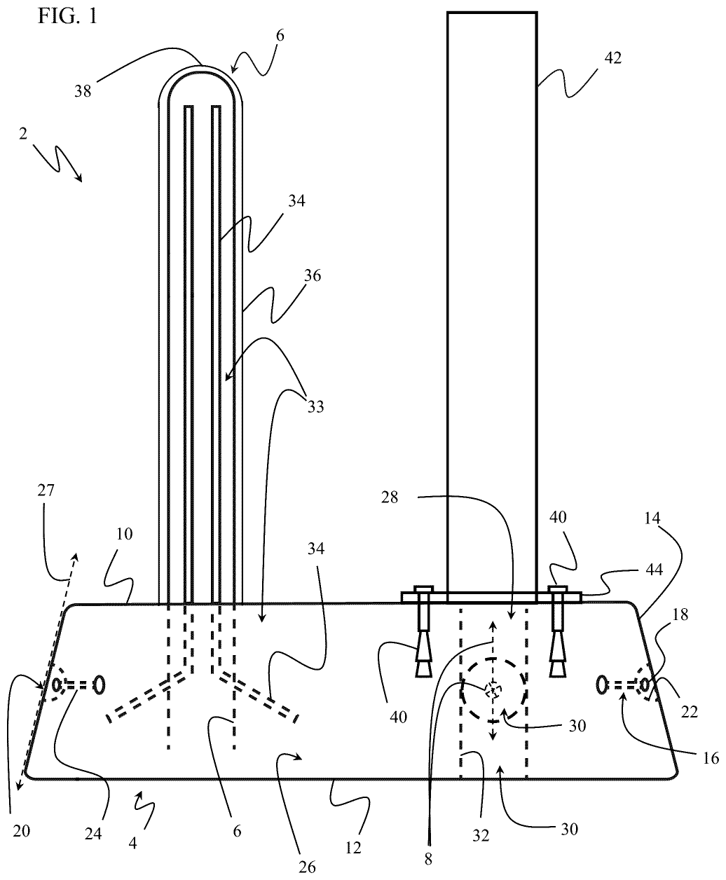

FIG. 1 is a front sectional view of an embodiment of a precast charging station pad as disclosed herein;

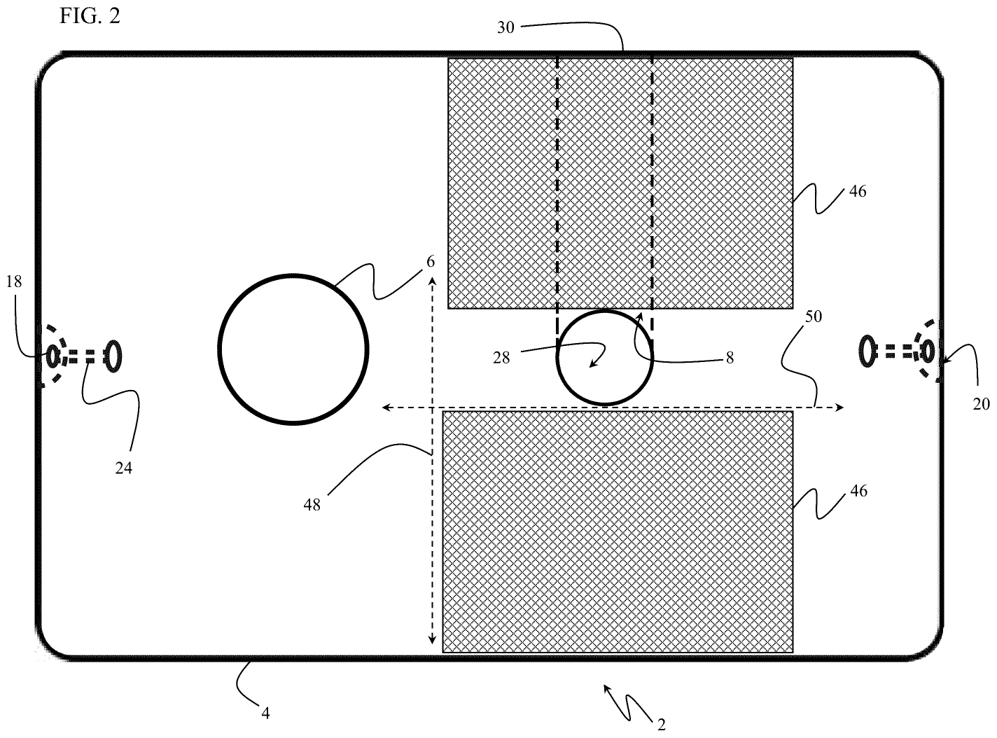

FIG. 2 is a top view of the precast charging station of FIG. 1;

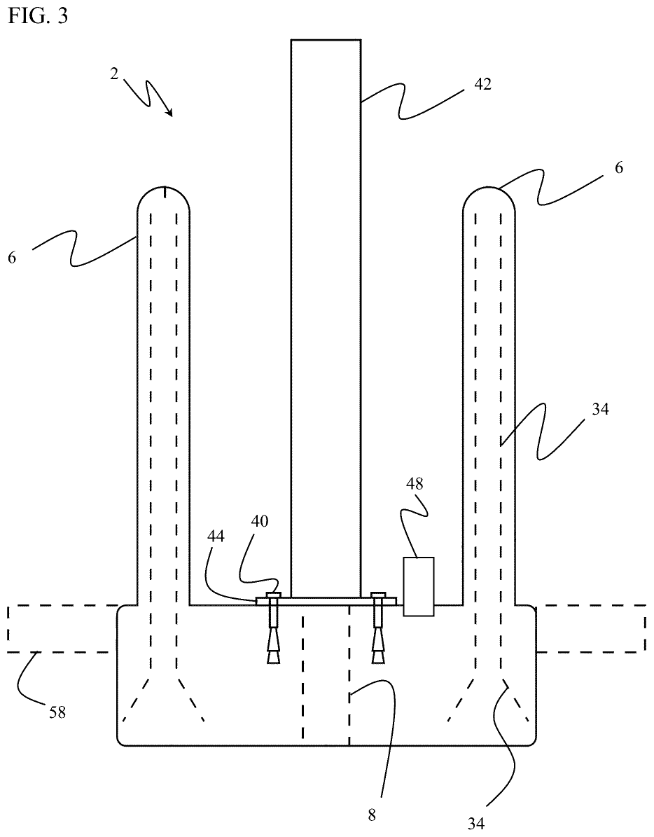

FIG. 3 is a front sectional view of a further embodiment of a precast charging station pad as disclosed herein;

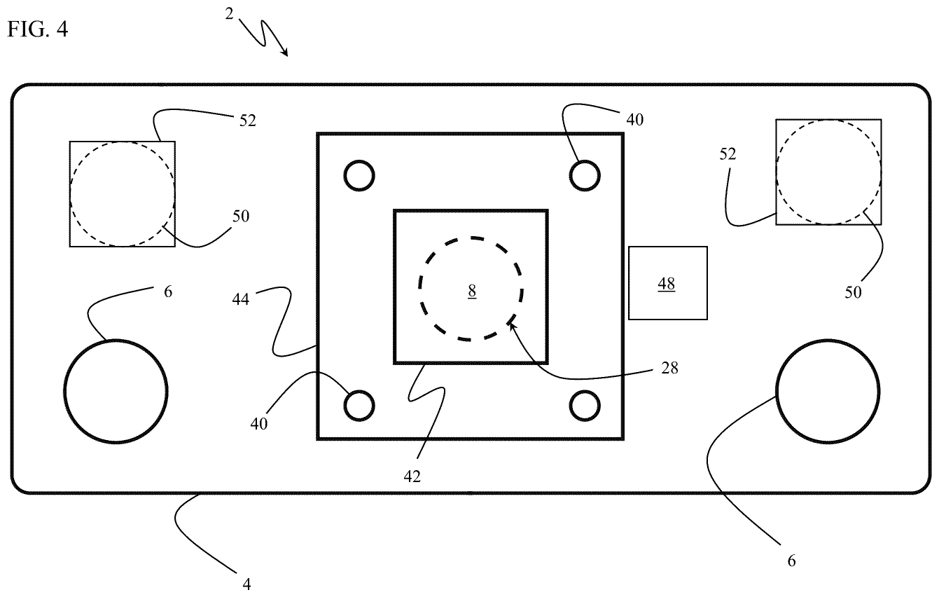

FIG. 4 is a top view of the precast charging station of FIG. 3;

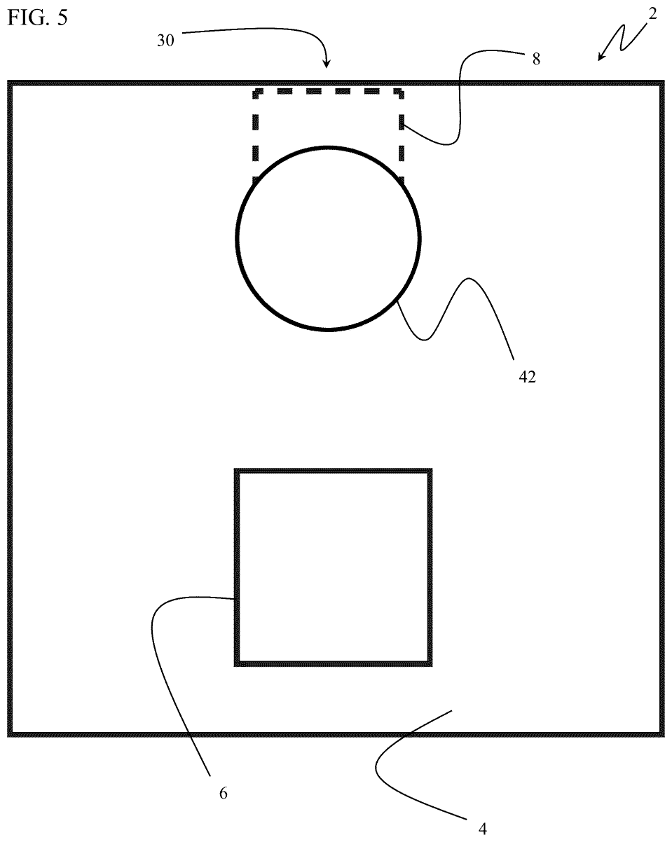

FIG. 5 is a top view of a further embodiment of a precast charging station pad as disclosed herein;

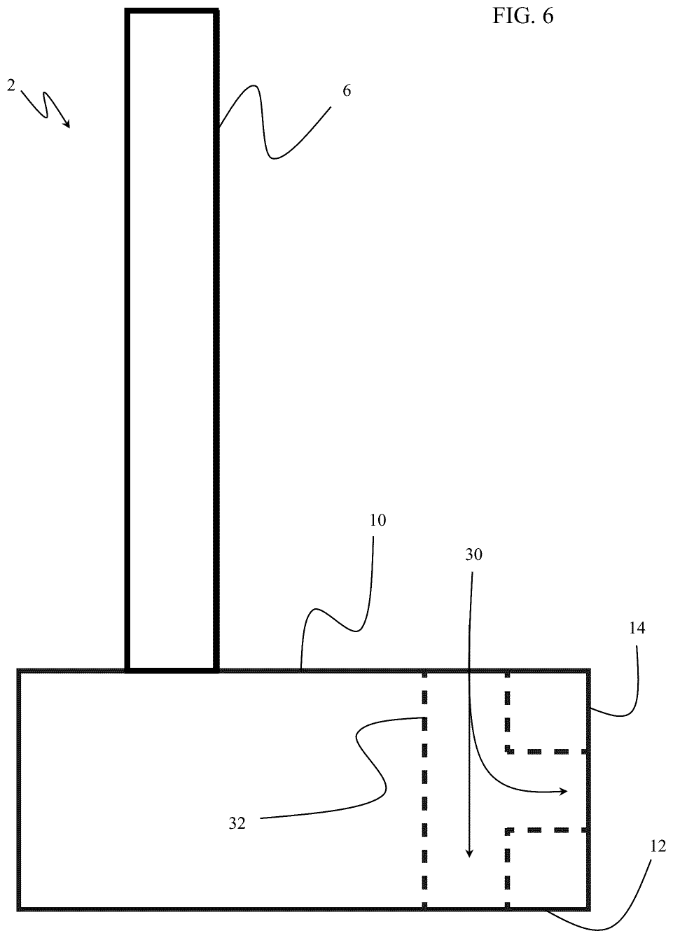

FIG. 6 is a side view of the precast charging station of FIG. 5;

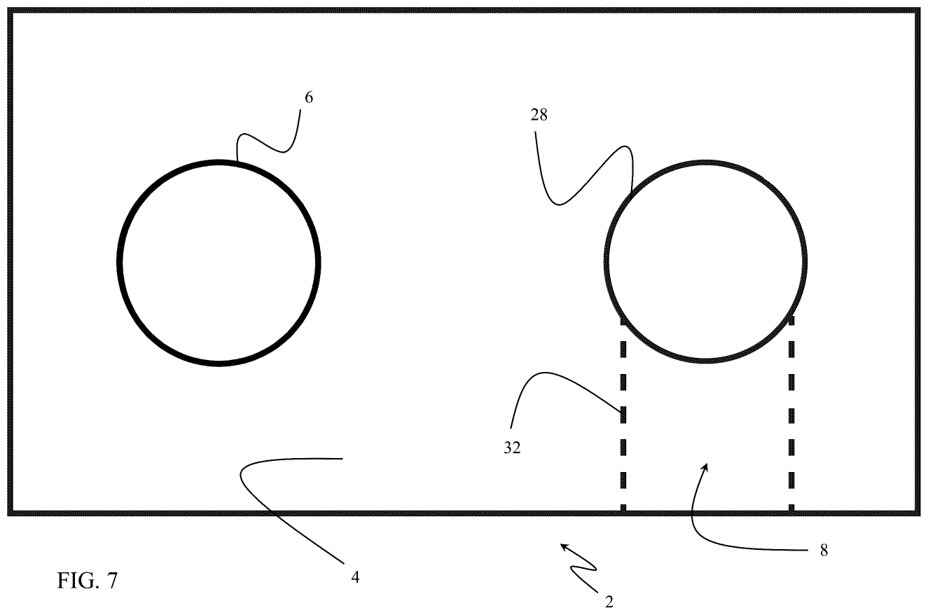

FIG. 7 is a top view of a further embodiment of a precast charging station pad as disclosed herein;

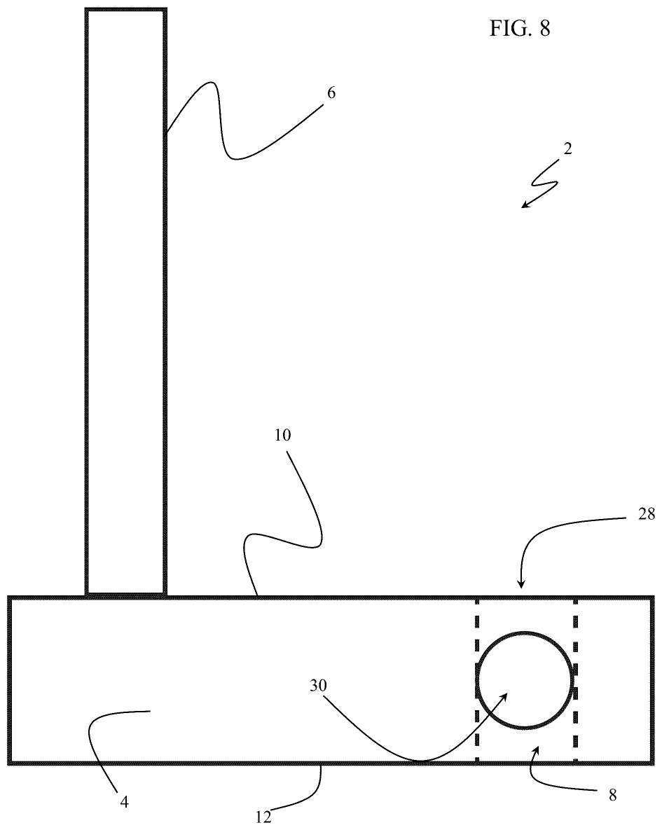

FIG. 8 is a side view of the precast charging station of FIG. 7;

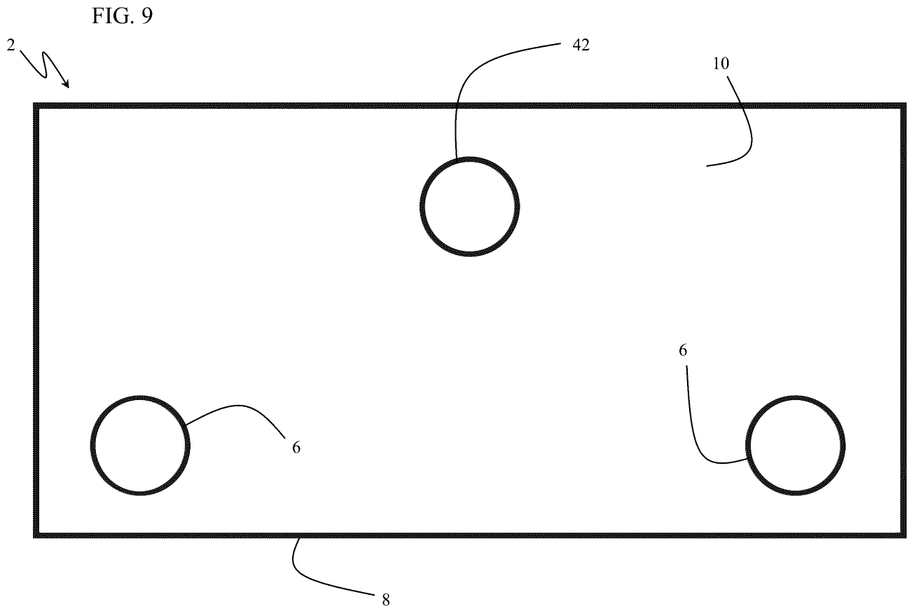

FIG. 9 is a top view of a further embodiment of a precast charging station pad as disclosed herein;

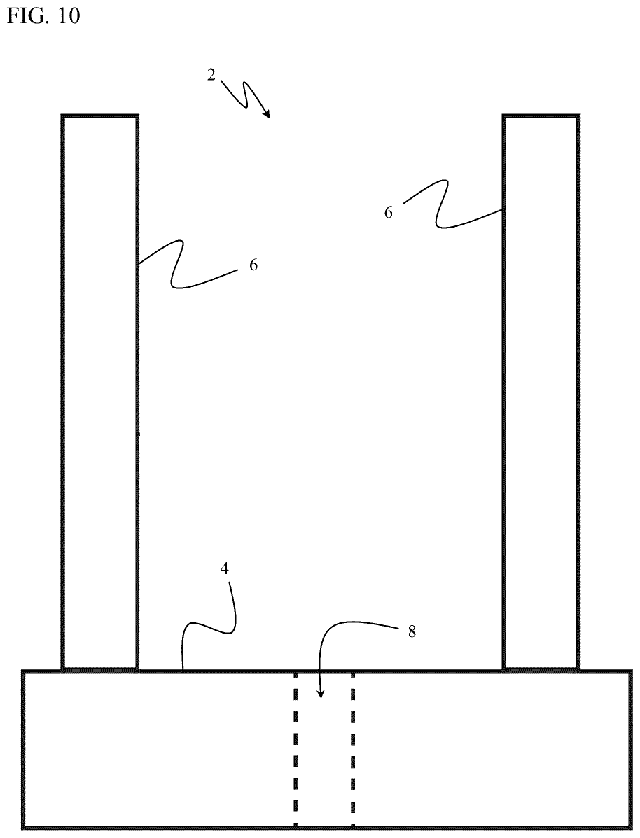

FIG. 10 is a side view of the precast charging station of FIG. 9;

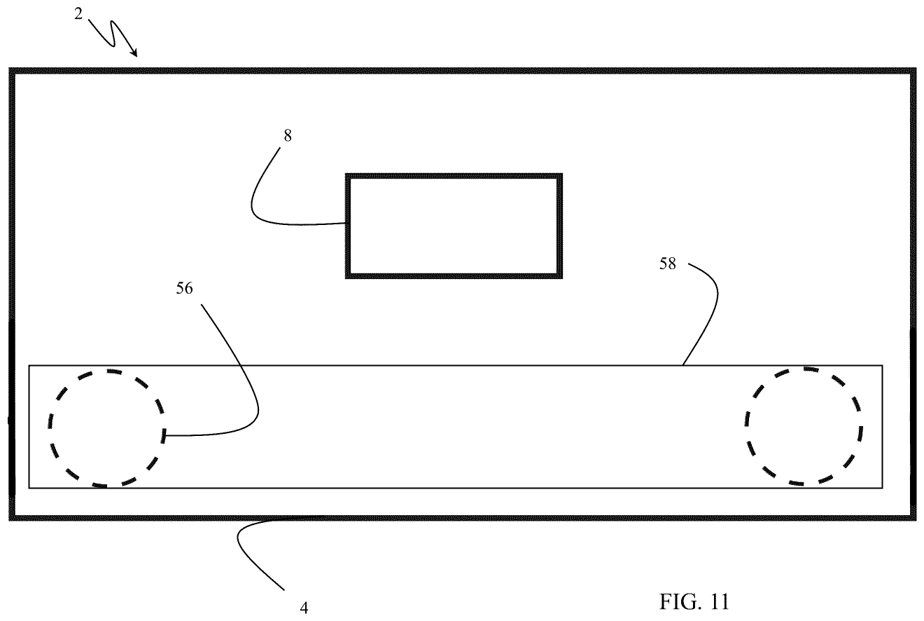

FIG. 11 is a top view of a further embodiment of a precast charging station pad as disclosed herein;

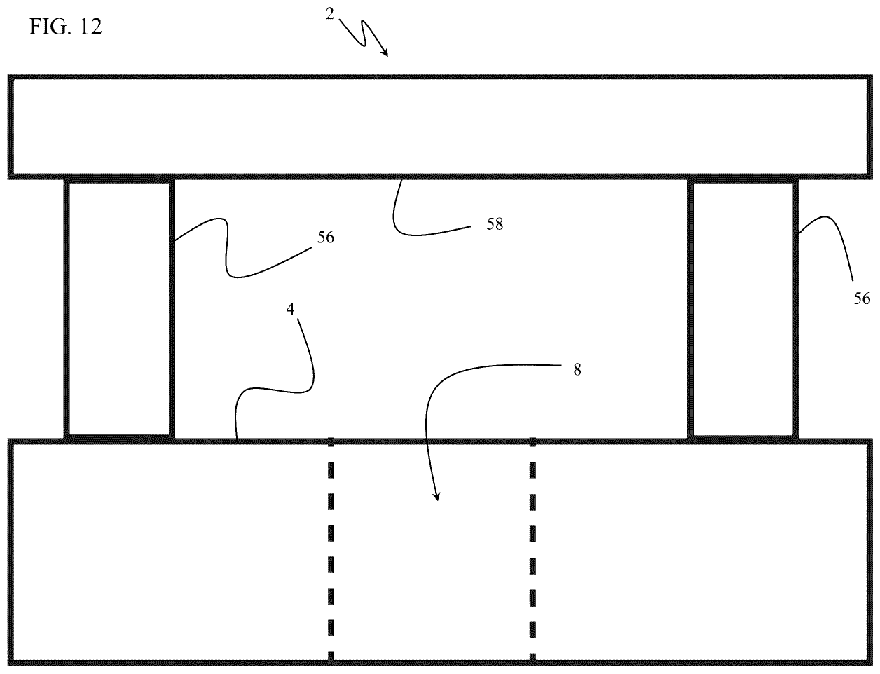

FIG. 12 is a side view of the precast charging station of FIG. 11; and

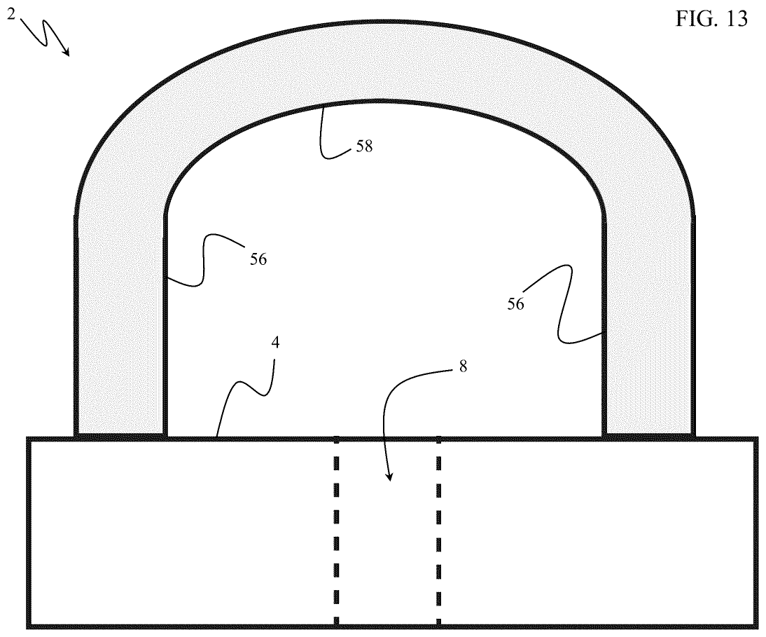

FIG. 13 is a side view of a further embodiment of a precast charging station pad as disclosed herein.

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The terms “comprise(s),” “include(s),” “having,” “has,” “can,” “contain(s),” and grammatical equivalents and variants thereof, as used herein, are intended to be open-ended transitional phrases, terms, or words that do not preclude the possibility of additional acts or structures. are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. The singular forms “a,” “and” and “the” include plural references unless the context clearly dictates otherwise. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. Where spatial directions are given, for example above, below, top, and bottom, such directions refer to the precast charging station pad as represented in FIG. 1 unless identified otherwise.

The embodiments set forth the below represent the necessary information to enable those skilled in the art to practice the invention and illustrate the best mode of practicing the invention. For the measurements listed, embodiments including measurements plus or minus the measurement times 5%, 10%, 20%, 50% and 75% are also contemplated. For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “substantially” means that the property is within 80% of its desired value. In other embodiments, “substantially” means that the property is within 90% of its desired value. In other embodiments, “substantially” means that the property is within 95% of its desired value. In other embodiments, “substantially” means that the property is within 99% of its desired value. For example, the term “substantially complete” means that a process is at least 80% complete, for example. In other embodiments, the term “substantially complete” means that a process is at least 90% complete, for example. In other embodiments, the term “substantially complete” means that a process is at least 95% complete, for example. In other embodiments, the term “substantially complete” means that a process is at least 99% complete, for example.

The term “substantially” includes a value that is within 10% less than or greater than the indicated value. In certain embodiments, the value is within 5% less than or greater than of the indicated value. In certain embodiments, the value is within 2.5% less than or greater than of the indicated value. In certain embodiments, the value is within 1% less than or greater than of the indicated value. In certain embodiments, the value is within 0.5% less than or greater than of the indicated value.

The term “about” includes when value is within 10% of the indicated value. In certain embodiments, the value is within 5% of the indicated value. In certain embodiments, the value is within 2.5% of the indicated value. In certain embodiments, the value is within 1% of the indicated value. In certain embodiments, the value is within 0.5% of the indicated value.

In addition, the invention does not require that all the advantageous features and all the advantages of any of the embodiments need to be incorporated into every embodiment of the invention.

Turning now to FIGS. 1 to 13, a brief description concerning the various components of the present invention will now be briefly discussed. As can be seen in FIG. 1, the precast charging station pad 2 comprises a base 4, a barrier 6, and a conduit chase 8.

The base 4 is generally formed of precast concrete but may be built of other materials that provide sufficient structural strength, such as wood composites, plastics, metals, flyash, and a combination thereof, for example. The base 2 includes a top surface 10, a bottom surface 12, and a one or more side surfaces 14. The side surfaces 14 preferably slope outwardly from the top surface 10 to the bottom surface 12, to aid in drainage of rain from the top surface 10 and stability of the pad 2. In one embodiment, the base is between 0.50 and 2.0 feet high, preferably 1.0 feet high, by between 2.0 and 4.0 feet wide, preferably 3.0 feet wide, by between 1.0 and 3.0 feet long, preferably 2.0 feet long. The top view shape of the base may be rectangular, square, round, oval, hexagonal, or other shape as needed.

Preferably in one or more side surfaces 14 of the base 4 one or more lifting pins 16 are disposed. The lifting pins 16 are preferably cast into the base 4, and with an exposed portion 18 of the lifting pins 16 extending from a pin recess 20 disposed in the outer surface 22 of the base 4 and an enclosed portion 24 of the lifting pins 16 extending into the base interior 26. The lifting pins 16 aid in lifting and placement of the precast charging station pad 2 while preferably not extending outward from a surface plane 27 defined by a plane substantially tangent to a base side surface. The lifting pins 16 are preferably between 025 and 1.0 inches, more preferably 0.50 wide, and preferably between 2.0 and 8.0 inches, more preferably 4.0 inches long. The lifting pins may be, for example, dog bone shaped, as shown in FIG. 1. The lifting pins are preferably comprised of metal or carbon fiber, for example.

The conduit chase 8 is a through hole extending from a chase entrance 28 in the base top surface 10 to a chase exit 30 preferably in the base bottom surface 12 and/or base side surface(s) 14 and/or base top surface 10. In FIG. 1, for example, the conduit chase 8 is shown with two chase exits 30, one through the base bottom surface 12 and one through a base side surface 14. The conduit chase 8 is defined by chase walls 32 in the base interior 24. The conduit chase preferably measures between 1.0 and 6.0 inches in diameter, more preferably between 2.0 and 5.0 inches in diameter, and most preferably 4.0 inches in diameter. The conduit chase 8 preferably has a circular cross-sectional shape, but may have a rectangular, oval, square, or other cross-sectional shape as desired.

As shown in FIG. 1, the barrier 6 may be shaped as a substantially cylindrical bollard, but may have a square, rectangular, hexagonal, oval, or other shape as best fits the need. The barrier 6 is preferably an integrated protective device, that may be of varying diameter, varying cross sectional shape, varying height, varying quantity as required. The barrier is preferably constructed of concrete 33 and rebar 34, and/or steel pipe or steel tubing with or without concrete fill, and with and without plastic sleeving 36 as required. In a preferred embodiment, the barrier 6 measures between 2.0 and 8.0 inches in diameter, more preferably 4.5 inches in diameter, and between 2.0 and 5.0 feet high, more preferably 3.0 feet high, where height is measured from the base top surface 10 to a top of the barrier 6. The barrier 6 preferably includes one, two, three, or four sections of rebar 34. The rebar 34 may be made from carbon steel, stainless steel, galvanized, glass fiber, glass fiber reinforced polymer, carbon fiber, basalt fiber, epoxy coated, welded wire fabric, expanded metal, or some combination thereof, for example. The barrier 6 is preferably embedded into the base interior 26, such as the barrier 6 being in place in the base interior 26 when the concrete 33 is poured for the base 4, and/or the barrier 6 may be mechanically attached to the base 4 by a fastener 40, such as one or more of anchors, screws, bolts, nuts, nails, rivets, locks, and the like, for example. In further embodiments, the barrier 6 may be cast in unitary construction with the base.

A charging post 42 will preferably be attached to the base 4, preferably mechanically attached via a charging post anchor plate 44, for example, preferably with one or more fasteners 40. The charging post 42 will preferably be aligned with and communicate with the conduit chase 8, to allow connection of power cords passing through the conduit chase 8 to attach to electronics in the charging post 42.

In further embodiment, a portion of the base top surface 10 is formed with a textured surface 46. The textured surface 46 may be a tread, brushed or broom finished, or other shape cast, cut, or formed into the base top surface 10 to aid in traction for users standing on the base top surface 10, or may be a separate sheet or coating attached to the base top surface 10, such as a cross hatched metal plate, metal diamond plate, wire mesh, or other attachment that will increase traction for users. The textured surface 46 may be over a small portion of the base top surface 10, preferably the area adjacent to the location of the charging post 42, or may be over a majority of the base top surface 10, or may be of substantially the entirety of the base top surface 10. In the embodiment shown in FIG. 2, the textured surface 46 substantially measures in a first direction 48 along the base top surface 42 from one edge of the base top surface 10 to the chase entrance 28. In some embodiments, the textured surface 46 substantially measures in the first direction 48 along the base top surface 42 from one edge of the base top surface 10 to an opposite edge of the base of the top surface 10. The textured surface 46 preferably measures in an orthogonal second direction 50 along the base top surface 42 between 10.0 percent and 100.0 percent of the base top surface 10 in the second direction 50, preferably between 20.0 percent and 50.0 percent, most preferably between 30.0 percent and 40.0 percent. In some embodiments, as shown in FIG. 2., a first textured surface 46 extends from the chase entrance 28 to a first edge of the top surface 10 on a first side of chase entrance 28, and a second textured surface 46 extends from the chase entrance 28 to a second edge of the top surface 10 on one of an opposite or orthogonal side of chase entrance 28. In some embodiments, a third textured surface 46 extends from the chase entrance 28 to a third edge of the top surface 10 on the other of an opposite or orthogonal side of chase entrance 28. The textured surface preferably has a static coefficient of friction at least 20% higher than a non-textured surface of the base 4, more preferably 50% higher, most preferably 90% higher.

In further embodiments, as shown in FIGS. 3 and 4, one or more cast in electrical box 52 may be located at or near where the conduit entrance 28 to allow for prewiring of the various electronics.

In further embodiments, as shown in FIG. 4, knockouts 54 may be cast into the base 4 for placement of the barriers 6 and/or conduit chase 8. In further embodiments additional knockouts 54 may be present. These additional knockouts 54 allow for increased modularity and flexibility for number and placement of the barriers 6 and/or conduit chase 8 depending on the users' need. Preferably metal knockout covers 56 may cover the knockouts 54 when barriers 6 and/or conduit chase 8 are not present at the unused knockouts 54. The knockouts 54 may be partial indentations into the base 4 or through holes through the base 4.

In further embodiments, as shown in FIGS. 12 and 13, the barrier 6 may extend both vertically and horizontally (in one or both of the first and second directions 48, 50), with a portion of the barrier extending over but not contacting the base. In one embodiment, the barrier 6 is in an arch shape, with one or more legs 56 connected to one or more arches 58. The arch may be in a variety of shapes depending on the user's need, such as a flat arch shown in FIG. 12 or a round arch shown in FIG. 13.

The precast charging station pad 2 in the embodiment shown in FIG. 1 preferably weighs between 2,000.0 lbs. and 500.0 lbs., more preferably between 1,500.0 lbs. and 750.0 lbs., and most preferably 1000.0 lbs.

A preferred method of installing the precast charging station pad is as follows. Dig a hole preferably at least 6″ wider in each direction and as deep as required for a conduit. Fill the hole with sufficient crushed stone so that precast charging station pad will be level with a final grade. Place precast charging station pad over the conduit (installed prior to placement of the precast charging station pad) using lifting pins. Backfill around the precast charging station pad, compacting soil preferably every 4 inches. Sidewalks 58 may be installed adjacent to the precast charging station 2 level with the base top surface 10.

In other embodiments, a taller and or wider bollard may be used, for example having a diameter of about 7.5 inches and a height of about 58.0 inches.

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. The present disclosure also contemplates other embodiments “comprising,” “consisting of” and “consisting essentially of,” the embodiments or elements presented herein, whether explicitly set forth or not. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items, while only the terms “consisting of” and “consisting only of” are to be construed in the limitative sense.

### REFERENCE NUMBERS

2 precast charging station pad
4 base
6 barrier
8 conduit chase
10 top surface of base
12 bottom surface of base
14 side surface of base
16 lifting pins
18 exposed portion of lifting pin
20 pin recess
22 outer surface of base
24 enclosed portion of lifting pin
26 base interior
27 surface plane
28 chase entrance
30 chase exit
32 chase walls
33 concrete
34 rebar
36 plastic sleeving
38 top of barrier
40 fastener
42 charging post
44 anchor plate
46 textured surface
48 first direction
50 second direction
52 cast in electrical box
54 knock out
56 knock out cover
58 sidewalk

Wherefore, I/We claim:

1. A precast charging station pad comprising:
a base;
a first barrier attached to the base; and
a conduit chase extending through the base.

2. The precast charging station pad of claim 1, wherein the conduit chase is a through hole extending from a top surface of the base, through an interior of the base, to one of a side surface of the base and a bottom surface of the base.

3. The precast charging station pad of claim 1, wherein the first barrier is a bollard.

4. The precast charging station pad of claim 1, wherein the first barrier includes rebar.

5. The precast charging station pad of claim 1, further comprising a second barrier.

6. The precast charging station pad of claim 5, wherein the first barrier is spaced from the second barrier in a first direction, and a conduit chase entrance is between the first and second barrier with respect to the first direction.

7. The precast charging station pad of claim 6, wherein the conduit chase entrance is offset in a second direction orthogonal to the first direction.

8. The precast charging station pad of claim 1, wherein the first barrier is cast into the base.

9. The precast charging station pad of claim 1, wherein the first barrier is mechanically attached to the base.

10. The precast charging station pad of claim 1, further comprising a charging post attached to the base.

11. The precast charging station pad of claim 1, wherein a first portion of a surface of the base adjacent to an entrance of the conduit chase has a higher static coefficient of friction than a second portion of the surface of the base.

12. The precast charging station pad of claim 1 wherein the barrier extends in both a vertical and horizontal direction, with a portion of the barrier extending over the base but spaced from the base in the vertical direction.

13. The precast charging station pad of claim 12, wherein the barrier has an arch and multiple legs connecting the arch to the base.

14. The precast charging station pad of claim 1, further comprising an electrical box precast into the base.

15. The precast charging station pad of claim 14, wherein the electrical box is adjacent to an entrance of the conduit chase.

16. The precast charging station pad of claim 1, further comprising one or more knockouts in the base, with a total number of knockouts being greater than a sum of a number of barriers and a number of conduit chases.

17. The precast charging station pad of claim 1, further comprising one or more lifting pins disposed in one or more side surfaces the base.

18. The precast charging station pad of claim 17, wherein a number of lifting pins is two, three, or four, and each lifting pin is partially embedded in a respective side surface of the base, with an exposed portion of each lifting pin extending from the base into a respective recess in the respective side surface of the base, but the exposed portion of each lifting pin not extending beyond the respective recess.

19. A precast charging station pad comprising:
a base formed of concrete;
a first barrier and a second barrier attached to the base;
a conduit chase extending through the base, the conduit chase being a through hole extending from a top surface of the base, through an interior of the base, to a bottom surface of the base;
a charging post positioned vertically over a conduit chase entrance;
an electrical box precast into the base at a location adjacent to the entrance of the conduit chase; and
between one and four lifting pins disposed in one or more side surfaces the base, where each lifting pin is partially embedded in a respective side surface of the base, with an exposed portion of each pin extending from the base into a respective recess in the respective side surface of the base, but not extending beyond the respective recess;
wherein the first and the second barrier are bollards filled with rebar reinforced concrete and covered in a plastic cap;
the first barrier is spaced from the second barrier in a first direction, and the conduit chase entrance is between the first and second barrier with regards to the first direction, but is offset in a second direction orthogonal to the first direction; and
a first portion of a surface of the base adjacent to an entrance of the conduit chase has a higher static coefficient of friction than a second portion of the surface of the base.

20. A method of installing a precast charging station pad having a base, one or more barriers, a conduit chase, and lifting pins, the method comprising:
digging a hole at least 6 inches wider in each direction as the precast charging station pad;
filling the hole with sufficient crushed stone so that the precast charging station pad will be level with a final grade;
installing a conduit;
placing the precast charging station pad over the conduit using lifting pins;
backfilling soil around the precast charging station pad; and
compacting the soil.
